(19) United States
(12) Patent Application Publication
(10) Pub. No.: US 2008/0198581 A1
(43) Pub. Date: Aug. 21, 2008

(54) TOUCH SENSOR TYPE LIGHT-EMISSION WRITING INSTRUMENT

(76) Inventors: Hyung-Bong LEE, Busan (KR); Dae-Gyu LEE, Busan (KR); Kyung-Tae LEE, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/033,981

(22) Filed: Feb. 20, 2008

(30) Foreign Application Priority Data
Feb. 21, 2007 (KR) KR10-2007-0017498

(51) Int. Cl. B43K 29/10

(52) U.S. Cl. 362/118

(57) ABSTRACT

Provided is a touch sensor type light-emission writing instrument such as a ball point pen or an automatic pencil, which includes an LED (Light-Emitting Diode) unit which is turned on or off by a touch sensor without special illumination at dark places or at night. The touch sensor type light-emission writing instrument includes an LED unit having two light-emission portions which are embedded in a leading-end opening portion of a body accommodating a pencil lead or a ball point internal chamber filled with viscous ink, and which emit light. The negative polarity of the LED unit is directly connected to a battery through a metal plate, a spring etc., in the writing instrument, and the positive polarity thereof is linked on an integrated-circuit (IC) board between the LED unit and the battery. The LED unit is turned on or off by detection of a touch sensor. Accordingly, in comparison with the conventional light-emission writing instrument employing the mechanical switching unit, the touch sensor type light-emission writing instrument employing the touch sensor type switching unit is simple in view of the structure, to thus decrease the number of trouble occurrence, and employs the LED unit having two light-emission portions, to thus provide good brightness so that shadow does not occur as well as to thus facilitate a switching operation of the LED unit, to offer a simply manipulative light-emission writing instrument.

### CROSS-REFERENCE TO RELATED APPLICATION

This application claims the benefit of Korean Patent Application No. 10-2007-0017498, filed on Feb. 21, 2007, in the Korean Intellectual Property Office, the disclosure of which is incorporated herein by reference.

### BACKGROUND OF THE INVENTION

1. Field of the Invention

The present invention relates to a touch sensor type light-emission writing instrument such as a ball point pen or an automatic pencil, which includes an LED (Light-Emitting Diode) unit which is turned on or off by a touch sensor without a special illumination device at dark places or at night.

2. Description of the Related Art

There have been a number of conventional light-emission writing instruments. However, these conventional light-emission writing instruments employ a mechanical switching unit, respectively. Thus, the conventional light-emission writing instruments have a complicated structure, respectively, and may be frequently out of order at the time of a long-term use. Further, since only one light-emission body is embedded in the LED unit of the conventional light-emission writing instrument and is installed at a position departing from the center of the LED unit, a shadow appears at the time of using the conventional light-emission writing instrument.

### SUMMARY OF THE INVENTION

To overcome inconveniences of the conventional art, it is an object of the present invention to provide a touch sensor type light-emission writing instrument including an LED unit having two light-emission portions which are embedded in a leading-end opening portion of a body accommodating a pencil lead or a ball point internal chamber filled with viscous ink, and which emit light, in which the negative polarity of the LED unit is directly connected to a battery through a metal plate, a spring etc., in the writing instrument, and the positive polarity thereof is linked on an integrated-circuit (IC) board between the LED unit and the battery, to thus turn on or off the LED unit by detection of a touch sensor.

Accordingly, in comparison with the conventional light-emission writing instrument employing the mechanical switching unit, the touch sensor type light-emission writing instrument employing the touch sensor type switching unit according to the present invention, is simple in view of the structure, to thus decrease the number of trouble occurrence, and employs the LED unit having two light-emission portions, to thus provide good brightness so that a shadow does not occur as well as to thus facilitate a switching operation of the LED unit, to offer a simply manipulative light-emission writing instrument.

To accomplish the above object of the present invention, there is provided a touch sensor type light-emission writing instrument comprising: a body member which contains an integrated circuit (IC) board and a battery unit for supplying electric power to the IC board; a grip member which is gripped by a user when writing and into one side of which a writing unit is inserted; a metallic connector which connects the body member and the grip member; a battery cap portion with which one side of the body member is capped so that the battery unit is not seceded from the inside of the body member; a leading-end member which is combined with the writing unit which has been inserted into the one side of the grip member; an LED (Light-Emitting Diode) unit which is housed in the leading-end member and is fixed by a fixing unit, in which two light-emission portions are embedded in the LED unit; and a touch sensor which is installed on the body member and is electrically connected with the IC board by user's touch, to thus turn on or off the LED (Light-Emitting Diode) unit having the embedded two light-emission portions.

Preferably but not necessarily, if an automatic pencil is applied as the writing unit, the negative electrode of the battery unit is connected to the negative lead pin of the LED (Light-Emitting Diode) unit, via an IC board spring, the IC board, a metallic cam cap, a fifth metal plate in a cam unit, a cam spring, an insulation tube cap, and a fourth metal plate which is installed in an outer groove in an insulation tube, in sequence, and the positive electrode of the battery unit which is connected to the positive lead pin of the LED (Light-Emitting Diode) unit, via a cap metallic element which is installed in the inner side of the battery cap portion, a first metal plate which is installed in the inner side of the body member, the IC board which is turned on or off by detection of the touch sensor, a second metal plate which is installed in the inner side of the body member, the metallic connector, and a third metal plate which is installed in the inner side of the grip member, in sequence.

Preferably but not necessarily, if a ball point pen is applied as the writing unit, the negative electrode of the battery unit is connected to the negative lead pin of the LED (Light-Emitting Diode) unit, via an IC board spring, the IC board, an insulation tube cap, and a fourth metal plate which is installed in an outer groove in an insulation tube, in sequence, and the positive electrode of the battery unit which is connected to the positive lead pin of the LED (Light-Emitting Diode) unit, via a cap metallic element which is installed in the inner side of the battery cap portion, a first metal plate which is installed in the inner side of the body member, the IC board which is turned on or off by detection of the touch sensor, a second metal plate which is installed in the inner side of the body member, the metallic connector, and a third metal plate which is installed in the inner side of the grip member, in sequence.

Preferably but not necessarily, the touch sensor type light-emission writing instrument further comprises a cap portion which is provided in order to cover the leading-end member.

Preferably but not necessarily, the cap portion comprises a clip portion to put the writing instrument into a pocket of a shirt, dress or clothes, and a convex lens which is formed at the other side of the cap portion, so that the writing instrument can be used as an illumination unit at a state where the cap portion is fitted with the leading-end member.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a perspective view showing a touch sensor type light-emission automatic pencil according to an aspect of the present invention;

FIG. 2 is a disassembly perspective view showing the touch sensor type light-emission automatic pencil of FIG. 1;

FIG. 3 is an electric wiring diagram of the touch sensor type light-emission automatic pencil of FIG. 1;

FIG. 4 is a perspective view showing a touch sensor type light-emission ball point pen according to another aspect of the present invention;

FIG. 5 a disassembly perspective view showing the touch sensor type light-emission ball point pen of FIG. 4;

FIG. 6 is an electric wiring diagram of the touch sensor type light-emission ball point pen of FIG. 4;

FIG. 7 is a perspective view of an LED (Light-Emitting Diode) unit which is applied in the present invention;

FIG. 8 is a cross-sectional view cut along a line C-C of FIGS. 3 and 6; and

FIG. 9 is a cross-sectional view cut along a line D-D of FIGS. 3 and 6.

### DETAILED DESCRIPTION OF THE INVENTION

Hereinbelow, a touch sensor type light-emission writing instrument such as a ball point pen or an automatic pencil according to the present invention will be described with reference to the accompanying drawings. Like reference numerals are assigned for like elements in the drawings.

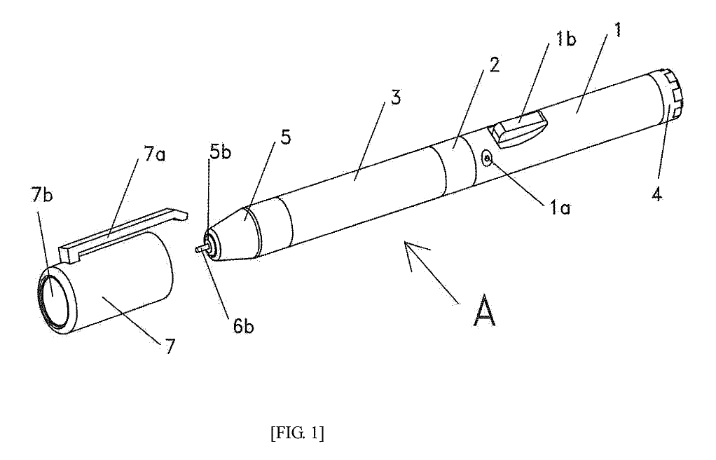

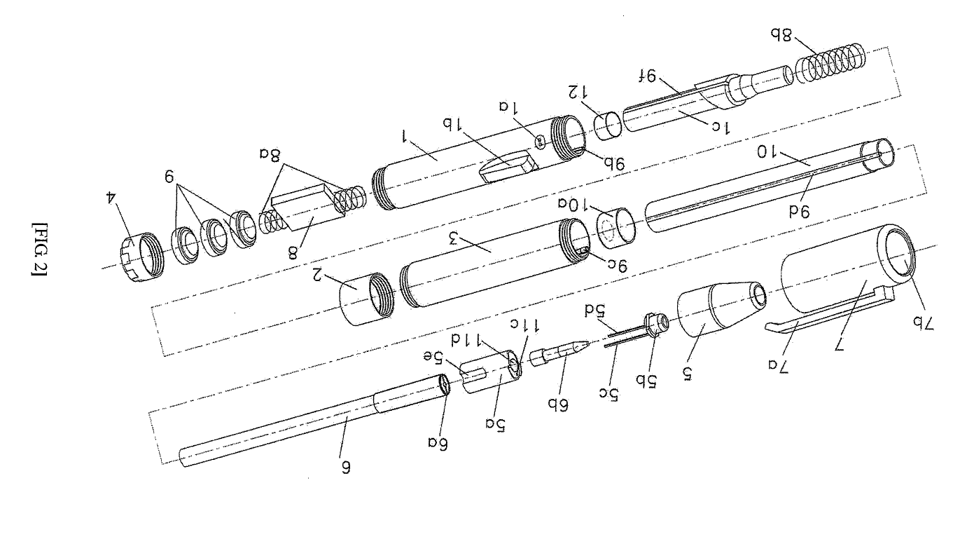

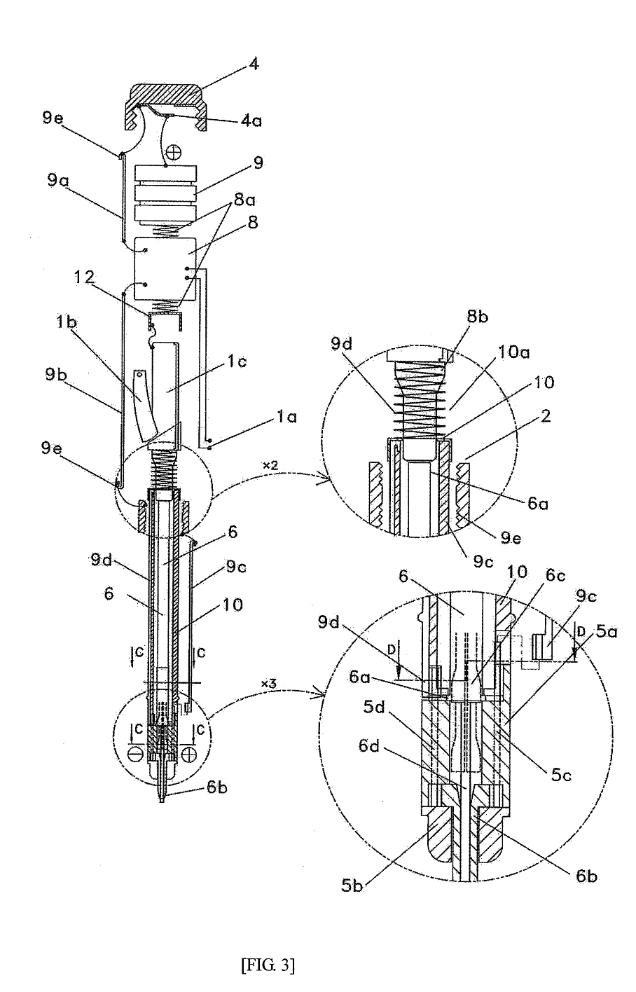

FIG. 1 is a perspective view showing a touch sensor type light-emission automatic pencil according to an aspect of the present invent ion, and FIG. 2 is a disassembly perspective view showing the touch sensor type light-emission automatic pencil of FIG. 1. FIG. 3 is an electric wiring diagram of the touch sensor type light-emission automatic pencil of FIG. 1.

As shown in FIGS. 1 to 3, a touch sensor type light-emission writing instrument employing a touch sensor 1a according to an aspect of the present invention is applied in an automatic pencil “A.” A body member 1 contains an integrated circuit (IC) board 8 and a battery unit 9 for supplying electric power to the IC board 8. Here, the battery unit 9 is inserted into the body member 1 through one end portion of the body member 1. A battery cap portion 4 is screw-tightened and connected with one side of the body member 1 in order to cap the one side of the body member 1 so that the battery unit 9 is not seceded from the inside of the body member 1.

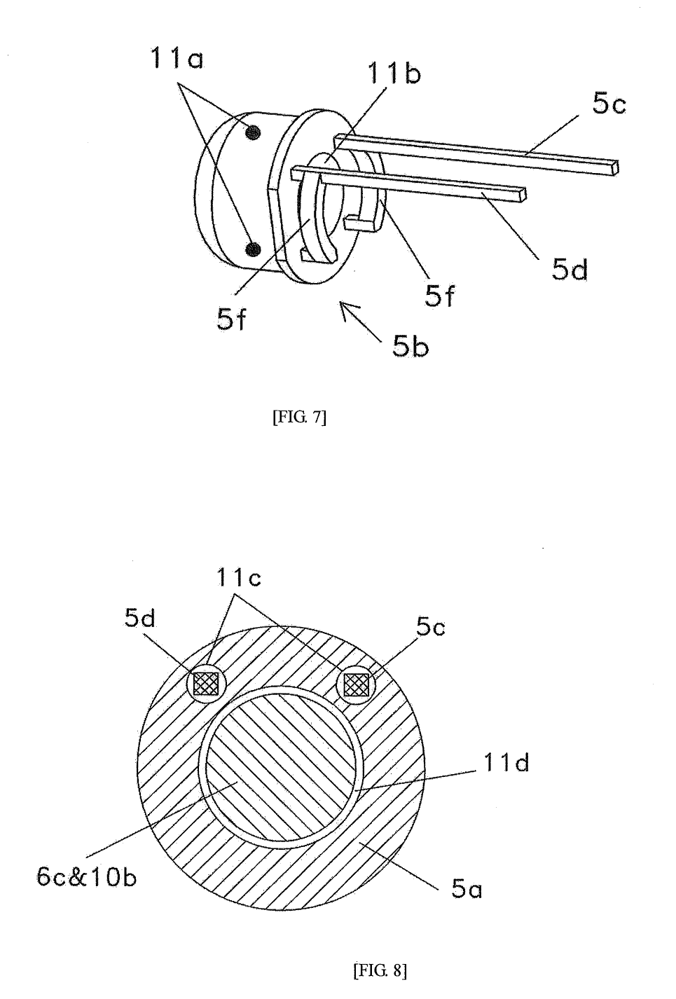

A leading-end member 5 is combined with a pencil tip portion 6b which has been inserted into the one side of a grip member 3. The touch sensor 1a is installed on the outer side of the body member 1 and is electrically connected with the IC board 8 by user's touch, to thus turn on or off an LED (Light-Emitting Diode) unit 5b having two light-emission portions 11a (of FIG. 7) embedded. The LED (Light-Emitting Diode) unit 5b is fitted through one side of the leading-end member 5, and the pencil tip portion 6b is fitted through the LED (Light-Emitting Diode) unit 5b.

A fixing unit 5a is fitted into the leading-end member 5. Accordingly, the LED (Light-Emitting Diode) unit 5b and the pencil tip portion 6b closely contact each other. Here, when the fixing unit 5a is fitted into the leading-end member 5, lead pins 5c and 5d of the LED (Light-Emitting Diode) unit 5b are fitted into a pin hole 11c. A pencil unit 6 is fitted up to a stopper 6a at one side of an insulation tube 10 as illustrated as an enlarged diagram in a larger circle at the lower side of FIG. 3. The pencil unit 6 is assembled with one side of the fixing unit 5a which makes the LED (Light-Emitting Diode) unit 5b and the pencil tip portion 6b fixed on the leading-end member 5, as illustrated as an enlarged diagram in a larger circle in the middle side of FIG. 3. Here, the negative polarity lead pin 5d of the LED (Light-Emitting Diode) unit 5b and protruded from a fixing unit groove 5e formed on the side surface of the fixing unit 5a is fitted into and assembled with a fourth metal plate 9d which is fitted into the outer groove of the insulation tube 10.

A grip member 3 is gripped by a user when writing and the pencil unit 6 is inserted into the insulation tube 10 and the grip member 3. The leading-end member 5 is screw-connected with and assembled with the grip member 3. In assembly, the positive polarity lead pin 5c of the LED (Light-Emitting Diode) unit 5b is fitted into and assembled with a third metal plate 9c which is fitted onto the inner side of the grip member 3.

An insulation tube cap 10a of a metallic material which plays a role of a conductor of the negative polarity is fitted into one side of the insulation tube 10 and contacts and is assembled with the fourth metal plate 9d. The insulation tube cap 10a contacts a cam spring 8b of a cam unit 1c which is housed in the body member 1, which is used as an electrical path of the negative electrode of the battery unit 9. A cam cap 12 which is fitted into one side of a fifth metal plate 9f which is fitted into the outer groove of the cam unit 1c contacts an IC (Integrated Circuit) board spring 8a, which is used as an electrical path of the negative electrode of the battery unit 9.

A metallic connector 2 screw-tightens and connects the body member 1 and the grip member 3, and contacts the positive polarity of a third metal plate 9c, which is used as an electrical path of the positive electrode of the battery unit 9 The metallic connector 2 contacts a second metal plate 9b which is fitted into the inner side of the body member 1, to thus contact an IC board 8. The IC board 8 is connected with the positive electrode of the battery unit 9 through a first metal plate 9a which is fitted into the inner side of the body member 1 ann a cap metallic unit 4a which is mounted in a battery cap portion 4.

The operation of the automatic pencil “A” will follow. If a user presses a cam button 1b mounted on the side surface of the body member 1, the cam unit 1c moves. Accordingly, a force is delivered to the pencil unit 6, and thus a withdrawal unit 6c operates in the fixing unit hole 11d of the fixing unit 5a and a pencil lead 6d is delivered and transferred to one side of the pencil tip portion 6b. Accordingly, the automatic pencil “A” plays a role of a writing instrument. Here, the touch sensor 1a mounted on the outer surface of the body member 1 senses user's contact to thus turn on or off the IC board 8, to then light up the LED (Light-Emitting Diode) unit 5b.

As shown in FIG. 3 which illustrates an electric wiring diagram of the touch sensor type light-emission automatic pencil of FIG. 1, the negative electrode of the battery unit 9 is connected to the negative lead pin 5d of the LED (Light-Emitting Diode) unit 5b, via the IC board spring 8a, the IC board 8, the metallic cam cap 12, a fifth metal plate 9f in the cam unit 1c, the cam spring 8b, the insulation tube cap 10a, and the fourth metal plate 9d which is installed in the outer groove in the insulation tube 10, in sequence. In addition, the positive electrode of the battery unit 9 which is connected to the positive lead pin 5c of the LED (Light-Emitting Diode) unit 5b, via a cap metallic element which is installed in the inner side of the battery cap portion 4, the first metal plate 9a which is installed in the inner side of the body member 1, the IC board 8 which is turned on or off by detection of the touch sensor 1a, the second metal plate 9b which is installed in the inner side of the body member 1, the metallic connector, 2 and the third metal plate 9c which is installed in the inner side of the grip member 3, in sequence.

An indent portion 9e is formed on the metal plates 9a, 9b, 9c and 9d, respectively, to then be closely fixed to the body member 1, the screw portion of the grip member 3, and the caps 10a and 12.

According to another aspect of the present invention, a touch sensor type light-emission writing instrument employing a touch sensor 1a is applied in a ball point pen “B” will be described below.

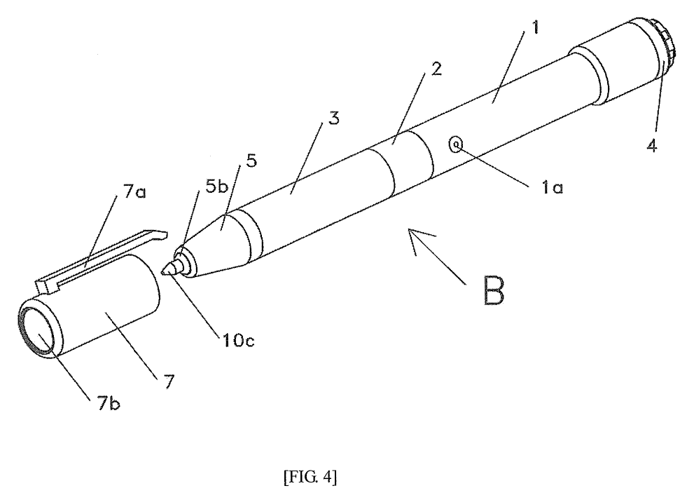

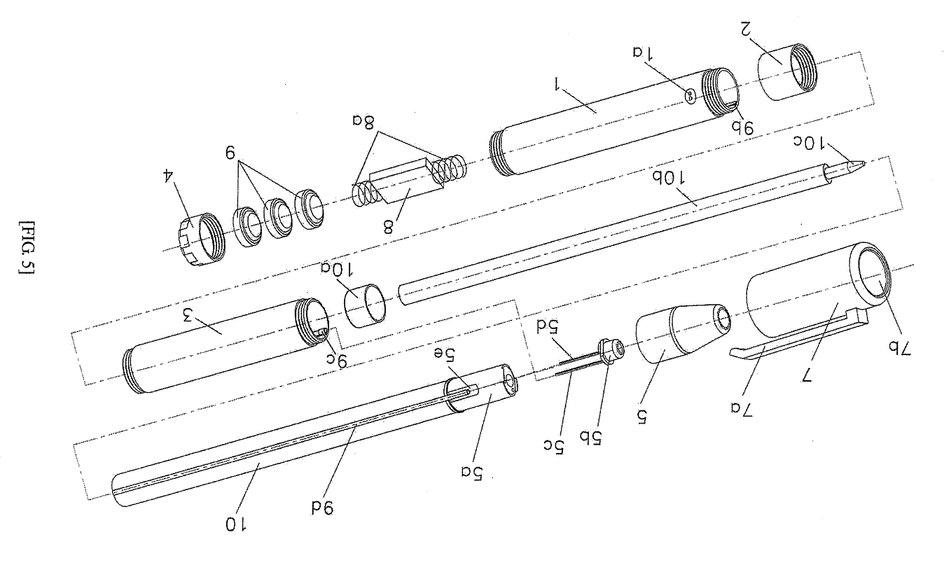

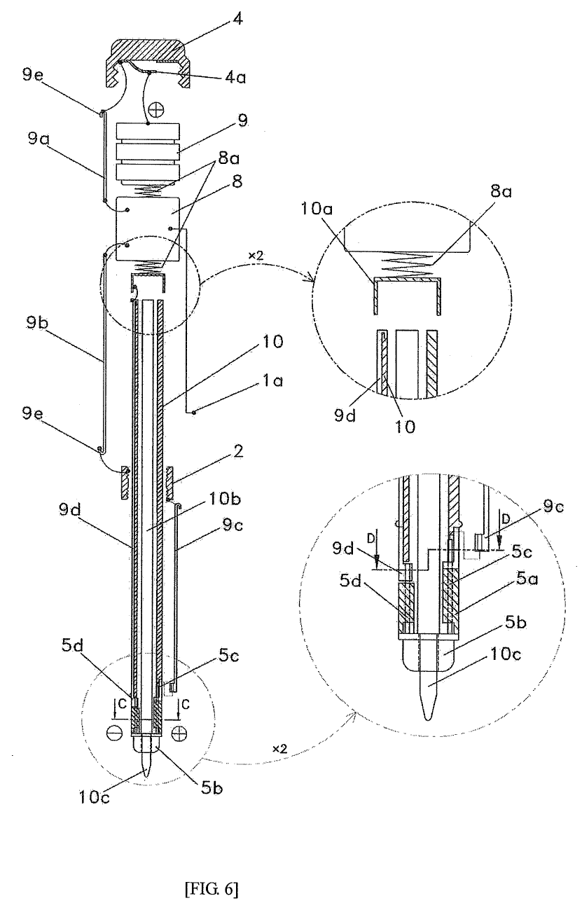

FIG. 4 is a perspective view showing a touch sensor type light-emission ball point pen according to another aspect of the present invention, and FIG. 5 a disassembly perspective view showing the touch sensor type light-emission ball point pen of FIG. 4. FIG. 6 is an electric wiring diagram of the touch sensor type light-emission ball point pen of FIG. 4.

As shown in FIGS. 4 to 6, a body member 1 contains an integrated circuit (IC) board 8 and a battery unit 9 for supplying electric power to the IC board 8. Here, the battery unit 9 is inserted into the body member 1 through one end portion of the body member 1. A battery cap portion 4 is screw-tightened and connected with one side of the body member 1 in order to cap the one side of the body member 1 so that the battery unit 9 is not seceded from the inside of the body member 1.

A leading-end member 5 is combined with a grip member 3. The touch sensor la is installed on the outer side of the body member 1 and is electrically connected with the IC board 8 by user's touch, to thus turn on or off an LED (Light-Emitting Diode) unit 5b having two light-emission portions 11a (of FIG. 7) embedded. The LED (Light-Emitting Diode) unit 5b is fitted through one side of a leading-end member 5. A fixing unit 5a is integrated with an insulation tube 10. The fixing unit integrated insulation tube 10 is fitted into the leading-end member 5 into which the LED (light-emitting diode) unit 5b is fitted. Here, lead pins 5c and 5d of the LED (Light-Emitting Diode) unit 5b are fitted into a pin hole 11c.

Here, the negative polarity lead pin 5d of the LED (Light-Emitting Diode) unit 5b and protruded from a fixing unit groove 5e formed on the side surface of the fixing unit 5a is fitted into and assembled with a fourth metal plate 9d which is fitted into the outer groove of the insulation tube 10.

A grip member 3 is gripped by a user when writing and a ball point pen unit formed of a ball point internal chamber 10b and a ball point pen tip 10c is inserted into the insulation tube 10 and the grip member 3. The leading-end member 5 is screw-connected with and assembled with the grip member 3. In assembly, the positive polarity lead pin 5c of the LED (Light-Emitting Diode) unit 5b is fitted into and assembled with a third metal plate 9c which is fitted onto the inner side of the grip member 3.

As illustrated as an enlarged diagram in a larger circle at the lower side of FIG. 3 as well as an enlarged diagram in a larger circle in the middle side of FIG. 3, the ball point internal chamber 10b is inserted into one side of the insulation tube 10, and is capped with an insulation tube cap 10a, which is formed of a metallic material and which plays a role of a conductor of the negative polarity. Thus, a third plate 9c of the insulation tube 10 contacts the insulation tube cap 10a and the insulation tube cap 10a contacts an IC (Integrated Circuit) board spring 8a, which is used as an electrical path of the negative electrode of the battery unit 9.

A metallic connector 2 screw-tightens and connects the body member 1 and the grip member 3, and contacts the positive polarity of a third metal plate 9c, which is used as an electrical path of the positive electrode of the battery unit 9. The metallic connector 2 contacts a second metal plate 9b which is fitted into the inner side of the body member 1, to thus contact an IC board 8. The IC board 8 is connected with the positive electrode of the battery unit 9 through a first metal plate 9a which is fitted into the inner side of the body member 1 ann a cap metallic unit 4a which is mounted in a battery cap portion 4.

In the case of the ball point pen “B,” the screw tightened metallic connector 2 is opened, to thus open the insulation tube cap 10a and substitute one ball point internal chamber 10b with another.

Here, the touch sensor 1a mounted on the outer surface of the body member 1 senses user's contact to thus turn on or off the IC board 8, to then light up the LED (Light-Emitting Diode) unit 5b.

As shown in FIG. 6 which illustrates an electric wiring diagram of the touch sensor type light-emission ball point pen of FIG. 4, the negative electrode of the battery unit 9 is connected to the negative lead pin 5d of the LED (Light-Emitting Diode) unit 5b, via the IC board spring 8a, the IC board 8, the insulation tube cap 10a, and the fourth metal plate 9d which is installed in the outer groove in the insulation tube 10, in sequence, and the positive electrode of the battery unit 9 is connected to the positive lead pin 5c of the LED (Light-Emitting Diode) unit 5b, via the cap metallic element 4a which is installed in the inner side of the battery cap portion 4, the first metal plate 9a which is installed in the inner side of the body member 1, the IC board 8 which is turned on or off by detection of the touch sensor 1a, the second metal plate 9b which is installed in the inner side of the body member 1, the metallic connector 2, and the third metal plate 9c which is installed in the inner side of the grip member 3, in sequence.

FIG. 7 is a perspective view of an LED (Light-Emitting Diode) unit 5b which is applied in the present invention. As shown in FIG. 7, the LED (Light-Emitting Diode) unit 5b includes a through hole 11b formed at the center thereof so that the pencil tip portion 6b or the ball point pen tip portion 10c can be fitted via the through hole 11b. Two light-emission portions 11a are embedded in the respective sides of the through hole 11b of the LED unit 5b. For this purpose, the lead pins 5c and 5d are connected in parallel with each other, by a connection pin 5f, respectively. Accordingly, when the electric power is supplied to the two light-emission portions 11a from the battery unit 9, it becomes brighter in comparison with the case using only one light-emission portion and a shadow of the pencil tip portion 6b or the ball point pen tip portion 10c does not occur.

FIG. 8 is a cross-sectional view cut along a line C-C of FIGS. 3 and 6. As shown in FIG. 8, the fixing unit 5a includes a fixing unit hole 11d penetrating through the center thereof, so that a pencil unit 6 and a ball point internal chamber 10b is inserted through the fixing unit hole 11d. In addition, the fixing unit 5a includes pin holes 11c through which the positive and negative lead pins 5c and 5d of the LED (Light-Emitting Diode) unit 5b are inserted. The fixing unit 5a fixes the LED (Light-Emitting Diode) unit 5b which is fitted into the leading-end member 5, at one side of the fixing unit 5a. The other side of the fixing unit 5a is integrated with the insulation tube 10. However, the fixing unit 5a may be alternatively fitted into and fixed to the insulation tube 10. The fixing unit hole 11d plays a role of an operational space for the withdrawal unit 6c of the pencil unit 6 or the ball point pen tip 10c and the ball point pen internal chamber 10b. That is, the fixing unit hole 11d has a useful structure of substituting a ball point internal chamber 10b with another, or withdrawing a pencil lead.

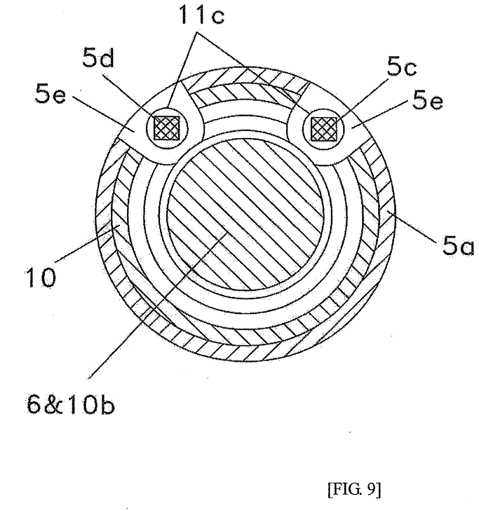

FIG. 9 is a cross-sectional view cut along a line D-D of FIGS. 3 and 6. Fixing unit grooves 5e are provided in the fixing unit 5a, in order to connect lead pins 5c and 5d that pass through pin holes 11c of the fixing unit 5a with the third and fourth metal plates 9c and 9d, respectively.

As shown in FIGS. 1, 2, 4, and 5, a cap portion 7 is provided in order to cover the leading-end member 5 to protect the pencil tip portion 6b or the ball point pen tip portion 10c. When writing, the cap portion 7 is fitted onto the battery cap portion 4. In addition, the cap portion 7 includes a clip portion 7a to put the writing instrument into a pocket of a shirt, dress or clothes. In addition, if a convex lens 7b is formed at the other side of the cap portion 7, the writing instrument can be used as an illumination unit at a state where the cap portion 7 is fitted with the leading-end member 5.

As described above, the present invention provides a touch sensor type light-emission writing instrument in which a touch sensor type light-emission device including an LED (Light-Emitting Diode) unit, a touch sensor, an IC board, and a battery unit, is employed in a mechanical or automatic pencil or a ball point pen. Accordingly, the touch sensor type light-emission writing instrument can be conveniently used since the LED (Light-Emitting Diode) unit is easily turned on or off by user's touch of the touch sensor at dark places or at night, without having a separate flash device. In addition, since two light-emitting portions 11a are embedded in the LED (Light-Emitting Diode) unit 5b, shadows do not occur by the pencil tip portion 6b or the ball point pen tip portion 10c. Further, the touch sensor type light-emission writing instrument is simple in its structure, it is not frequently out of order.

The present invention is not limited to the above-described embodiments. It is apparent to one who has an ordinary skill in the art that there may be many modifications and variations within the same technical spirit of the invention.

What is claimed is:

1. A touch sensor type light-emission writing instrument comprising:
a body member which contains an integrated circuit (IC) board and a battery unit for supplying electric power to the IC board;
a grip member which is gripped by a user when writing and into one side of which a writing unit is inserted;
a metallic connector which connects the body member and the grip member;
a battery cap portion with which one side of the body member is capped so that the battery unit is not seceded from the inside of the body member;
a leading-end member which is combined with the writing unit which has been inserted into the one side of the grip member;
an LED (Light-Emitting Diode) unit which is housed in the leading-end member and is fixed by a fixing unit, in which two light-emission portions are embedded in the LED unit; and
a touch sensor which is installed on the body member and is electrically connected with the IC board by user's touch, to thus turn on or off the LED (Light-Emitting Diode) unit having the embedded two light-emission portions.

2. The touch sensor type light-emission writing instrument according to claim 1, wherein if an automatic pencil is applied as the writing unit, the negative electrode of the battery unit is connected to the negative lead pin of the LED (Light-Emitting Diode) unit, via an IC board spring, the IC board, a metallic cam cap, a fifth metal plate in a cam unit, a cam spring, an insulation tube cap, and a fourth metal plate which is installed in an outer groove in an insulation tube, in sequence, and
the positive electrode of the battery unit is connected to the positive lead pin of the LED (Light-Emitting Diode) unit, via a cap metallic element which is installed in the inner side of the battery cap portion, a first metal plate which is installed in the inner side of the body member, the IC board which is turned on or off by detection of the touch sensor, a second metal plate which is installed in the inner side of the body member, the metallic connector, and a third metal plate which is installed in the inner side of the grip member, in sequence.

3. The touch sensor type light-emission writing instrument according to claim 1, wherein if a ball point pen is applied as the writing unit, the negative electrode of the battery unit is connected to the negative lead pin of the LED (Light-Emitting Diode) unit, via an IC board spring, the IC board, an insulation tube cap, and a fourth metal plate which is installed in an outer groove in an insulation tube, in sequence, and
the positive electrode of the battery unit is connected to the positive lead pin of the LED (Light-Emitting Diode) unit, via a cap metallic element which is installed in the inner side of the battery cap portion, a first metal plate which is installed in the inner side of the body member, the IC board which is turned on or off by detection of the touch sensor, a second metal plate which is installed in the inner side of the body member, the metallic connector, and a third metal plate which is installed in the inner side of the grip member, in sequence.

4. The touch sensor type light-emission writing instrument according to any one of claims 1 to 3, further comprising a cap portion which is provided in order to cover the leading-end member.

5. The touch sensor type light-emission writing instrument according to claim 1, wherein the cap portion comprises a clip portion to put the writing instrument into a pocket of a shirt, dress or clothes, and a convex lens which is formed at the other side of the cap portion, so that the writing instrument can be used as an illumination unit at a state where the cap portion is fitted with the leading-end member.
